(19) United States
(12) Patent Application Publication
(10) Pub. No.: US 2007/0039937 A1
(43) Pub. Date: Feb. 22, 2007

(54) METHODS FOR MANUFACTURING FLUX CORED WIRE FOR WELDING STAINLESS STEEL AND PRODUCTS THEREOF

(76) Inventors: Jong Hun Jang, Changwon-si (KR); Byung Ho Park, Changwon-si (KR)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/463,225

(22) Filed: Aug. 8, 2006

(30) Foreign Application Priority Data
Aug. 22, 2005 (KR) 10-2005-76596

(51) Int. Cl. B23K 35/02

(52) U.S. Cl. 219/145.22

(57) ABSTRACT

Disclosed is a method for manufacturing a flux cored wire for welding stainless steel of 0.9-1.6 mm in diameter having a seamed portion, which the method includes the steps of: forming a hoop (stainless steel 304L or 316L) into a U-shape and filling the hoop with a flux mixture, thereby forming a tube having a seamed portion; performing a primary drawing process on the tube shaped wire using a lubricant; performing a bright annealing process to relieve work hardening of the primarily drawn wire; performing a secondary drawing process on the wire until an accumulated reduction ratio after the bright annealing process falls within the range of 38-60%; physically removing a lubricant residue on the surface of the secondarily drawn wire; and coating the wire with a surface treatment agent.

### CROSS-REFERENCE TO RELATED APPLICATIONS

This application claims benefit under 35 U.S.C. § 119 from Korean Patent Application No. 10-2005-0076596, filed on Aug. 22, 2006, the entire content of which is incorporated herein by reference.

### BACKGROUND OF THE INVENTION

1. Field of the Invention

The present invention relates to methods for manufacturing a flux cored wire (FCW) for welding stainless steel, more specifically, to methods for manufacturing a flux cored wire for welding stainless steel with a seam for not only for manual welding but also for semiautomatic welding and robotic welding.

2. Description of the Related Art

In general, welding techniques for stainless steel include MIG, TIG, and flux cored wire welding.

First of all, MIG welding is a welding process which uses an expensive shielding gas, e.g., Ar inert gas or mixtures of Ar inert gas and 2-5% of O₂ or CO₂. The benefits of MIG welding include minimized spatter generation, and spray transfer (as a primary metal transfer mode) which serves to produce a stable arc and beautiful bead shapes. However, in case of using Ar inert gas or mixtures of Ar inert gas and 2-5% of O₂ or CO₂ as the shielding gas for welding, compared to a case where only CO₂ is used as the shielding gas, seam penetration is incomplete and a stable welding process is maintained in low amperages rather than high amperages. Thus, the MIG welding is limited its use in medium-sized or smaller stainless steels. In addition, as raw materials all over the world are in short supply nowadays, the relatively high cost of Ar inert gas limited its application in steels. In effect, the use of active gases such as CO₂ gas became common especially among small and medium enterprises. TIG welding, on the other hand, is a commonly used high quality welding process which does not result in burn-through or erosion of a welded sheet steel of 1 mm or smaller in thickness. However, the welding efficiency substantially deteriorates when it comes to welding at least 20 mm-thick plates. Even though high-quality and precise welding, TIG welding itself can be challenging for even the most skilled welder.

In the meantime, flux cored welding using flux cored wires has a broad range of applications because of its all position capability and high welding efficiency. Moreover, flux cored welding requires minimal or low operator skill, and its use of CO₂ gas saves the cost yet produces beautiful welding beads.

With recent advances in industrial technologies, diverse requirements such as high strength, light weight and superior corrosion resistance of steel plates have been added. Today, flux cored wires for welding stainless steel are commonly used in industries such as chemical plants, atomic power plants, construction welding in seawater and so on. As flux cored wires for welding stainless steel are used in a broad range of applications, a greater amount of flux cored wires is required and diverse user demands should be met. Even though flux cored wire welding for stainless steel was done manually in the past, more enterprises today prefer semi-automatic or automatic robotic welding.

Despite the benefits of semi-automatic or automatic robotic welding, such as, improved productivity and work efforts, many enterprisers have confessed difficulties in administrative management. For instance, unlike the traditional manual welding, a welding wire feed unit in the semi-automatic or automatic robotic welding system has a relatively longer cable (7-10 m). Thus, a bent or flexure is easily formed in the cable and in many cases this leads to an increase in the weld speed. One cannot deny that feedability of welding materials is a very important factor here.

In general, materials for welding some of mild steels and stainless steels are baked and a hard coated film is then formed on a wire surface to improve feedability. Also, by minimizing the amount of a lubricant residue after the drawing process, defect resistance of weld portions can be improved. However, the baked welding wires, compared with non-baked welding wires, have somewhat lower conductivity and reduced welding efficiency. Especially during a long-term welding process, a large amount of fume may be generated by the baked film.

Moreover, in case of performing a long-term robotic welding process, temperature at the welding tip increases due to poor conductivity and the welding tip easily abrades. Also, as oxidized film and wire-drawing lubricant clog a conduit cable, arc stability during welding is deteriorated and spatter generation is increased, which together serve to lower overall welding efficiency. As an attempt to resolve the problems caused by baked welding wires (e.g., deteriorations in weldability and efficiency of manufacturing processes and high manufacturing costs), many researches on non-baked welding wires are under way. Unfortunately however, compared with the baked welding wires, the non-baked welding wires have problems that the effect of removing the lubricant from the surface is not great and thus, defect resistance in weld portions is deteriorated during the welding process.

### SUMMARY OF THE INVENTION

It is, therefore, an object of the present invention to provide methods for manufacturing a flux cored wire for welding stainless steel with seams, which secures manufacturing efficiency, reduced manufacturing cost and good weldability (these are benefits of non-baked welding wires) and improves defect resistance caused by lubricant residue, whereby the flux cored welding wire features superior feedability and excellent defect resistance.

To achieve the above objects and advantages, there is provided a method for manufacturing a flux cored wire for welding stainless steel of 0.9-1.6 mm in diameter having a seamed portion, which the method includes the steps of: forming a hoop (stainless steel 304L or 316L) into a U-shape and filling the hoop with a flux mixture, thereby forming a tube having a seamed portion; performing a primary drawing process on the tube shaped wire using a lubricant; performing a bright annealing process to relieve work hardening of the primarily drawn wire; performing a secondary drawing process on the wire until an accumulated reduction ratio after the bright annealing process falls within the range of 38-60%; physically removing a lubricant residue on the surface of the secondarily drawn wire; and coating the wire with a surface treatment agent. Major factors of feedability and defect resistance of flux cored wires for welding stainless steel are surface roughness (Ra, μm) of a hoop, total moisture content (ppm) in the flux mixture filled in the hoop, types of lubricants used during the primary and secondary drawing steps, accumulated reduction ratio (%) during the secondary drawing step, and drawing methods (PCD dies or CRD). By categorizing and controlling these respective factors, one can integratedly manage all physical properties of the finished product, i.e., actual tensile strength (kgf/mm²; the tensile strength of areas except for the pore space on the cross section area of a finished wire), surface microhardness (Hv) of a wire, surface roughness (Ra), and total moisture content (ppm) in the surface of a wire.

### BRIEF DESCRIPTION OF THE DRAWINGS

The above aspects and features of the present invention will be more apparent by describing certain embodiments of the present invention with reference to the accompanying drawings, in which:

FIG. 1 is a schematic diagram showing the manufacturing process of a flux cored wire for welding stainless steel with seams, in accordance with one embodiment of the present invention;

FIG. 2 is a graph showing the relation between surface roughnesses (Ra) of a hoop and surface roughnesses (Ra) of a finished wire product (PCD dies are used for the primary and secondary drawing processes, and an accumulated reduction ratio in the secondary drawing is 50%);

FIG. 3 is a front elevatational view of a finished wire product in accordance with one embodiment of the present invention; and

FIG. 4 is a schematic view of test equipment having a curvature for evaluating feedability of a finished wire product in accordance with one embodiment of the present invention.

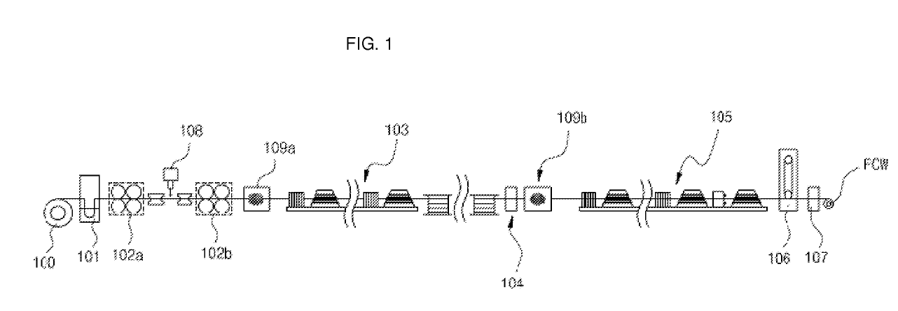

### DETAILED DESCRIPTION OF THE PREFERRED EMBODIMENTS

A preferred embodiment of the present invention will be described herein below, providing details on each step of the manufacturing process.

Cleaning Step and Hoop

304L or 316L stainless hoop (chemical compositions are shown in Table 1) as a raw material was washed with a cleaning solution to remove grease from processed oils or contaminants attached to the surface during the process. This is done because processed oils or contaminants remaining on the surface of the hoop may serve as the causes of an unstable arc or pore formation during welding.

The surface roughness (Ra) of the hoop is set to a range of 0.30 to 0.60 μm. By managing the surface roughness (Ra) of the hoop within a proper range, it becomes easy to manage the surface roughness (Ra) of a finished wire product and to control moisture content of the surface of a wire. The surface roughness (Ra) of the hoop can be controlled by diverse rolling processes.

If the surface roughness (Ra) of the hoop is below 0.30 μm, drawability in a step for forming a tube is not uniform which may result in a non-uniform filling rate and a lubricant during wire drawing may not be retained uniformly. On the other hand, if the surface roughness (Ra) of the hoop exceeds 0.60 μm, the amount of the lubricant residue during wire welding is increased and the surface roughness (Ra) of the finished wire product is increased, resultantly deteriorating wire feedability and defect resistance.

TABLE 1

| | Hoop | | | | | | | | | |
|---|---|---|---|---|---|---|---|---|---|---|
| | | | | | | | | | Physical properties | |
| | | | | | | | | | | Tensile |
| | Chemical compositions (wt %) | | | | | | | | Surface | strength |
| No. | C | Si | Mn | P | S | Cr | Ni | Mo | roughness (Ra) | (MPa) |
| a | 0.02 | 0.30 | 1.20 | 0.01 | 0.01 | 18.50 | 10.00 | 0.20 | 0.40 | 510 |
| b | 0.02 | 0.35 | 1.20 | 0.01 | 0.01 | 17.20 | 12.50 | 2.30 | 0.50 | 530 |

* The remainder includes Fe and other impurities.

The following now describes a flux mixture.

A flux having the ingredients shown in Table 2 below is filled in a stainless tube, and a total moisture content (adsorbed moisture and crystalline moisture) of a flux mixture should be 500 ppm or below with respect to the weight of the flux mixture.

Here, adsorbed moisture means moisture that is not chemically bonded but is adsorbed to the surface of a substance and easily evaporated when heated above 100° C. crystalline moisture means moisture that is not chemically bonded but has infiltrated pores, not molecular structured lattice in H⁺ and OH⁻ patterns, and is evaporated into the air when heated at 950° C. for more than 1 hour.

If the total moisture content of the flux mixture filled in a tube exceeds 500 ppm, its influence on the manufacturing process increases, resulting in undesirable defects on the surface of welded beads.

More details on the adsorbed moisture and crystalline moisture are now provided in the following embodiment. A weight reduction method is used to measure moisture content, that is, 50 g of a flux mixture material is heated at 950° C. or above for at least one hour and the amount of moisture evaporated into the air is calculated.

[Formula 1]
Total moisture content in flux mixture (ppm)={(Wa−Wb)/Wa}×10⁶
(in which, Wa is the weight (g) of a flux mixture material and Wb is the weight (g) measured after heating the flux mixture material at 950° C. for one hour.)

The flux mixture mainly consists of minerals, metals or at least two-component oxides. Such flux contains moisture inevitably adsorbed during the refining process or infiltrated into pores of molecular structures as well as moisture absorbed from the air, and a part of the moistures are evaluated through seams during a bright annealing process (a heat treatment that moderates work hardening of a wire and burns a lubricant residue on the surface under high-temperature reduction atmosphere conditions) while another part of the moisture remain inside the tube. Knowing that these residual moistures are the main cause of weld defects, inventors tried to manage the moisture content without carrying out the baking process, and eventually improve defect resistance.

In order to minimize the total moisture content in the flux mixture, the inventors measured the amount of adsorbed moisture and the amount of crystalline moisture in the respective fluxes using the same weight reduction method as in measurement of a total moisture content in the final flux mixture, and completely excluded the fluxes which contain much moisture already or may further absorb a large quantity of moisture. As for designing flux mixtures (a, b) shown in Table 2 below, the inventors used diverse flux materials as a resource of oxides, such as, TiO₂, SiO₂, ZrO₂, K₂O and the like, and adjusted only the total moisture contents in the flux mixtures without changing the final contents of the oxides in order to evaluate the degree of influence thereof. Typically, natural rutile sand, ilmenite or refined rutile may be used as a resource of TiO₂.

TABLE 2

| | Chemical compositions of flux (%, weight ratio with respect to total weight of wire) | | | | | | | | | | | |
|---|---|---|---|---|---|---|---|---|---|---|---|---|
| No. | TiO₂ | SiO₂ | ZrO₂ | K₂O | Mn | Cr | Ni | Mo | Al | C | Fe | Total |
| a | 9.50 | 1.52 | 1.56 | 0.12 | 0.80 | 3.80 | 2.60 | 1.81 | 0.08 | 0.01 | 2.20 | 24.0 |
| b | 6.30 | 1.04 | 0.99 | 0.10 | 0.76 | 3.65 | 0.63 | 0.01 | 0.01 | 0.01 | 1.50 | 15.0 |

Flux Filling and Forming Process

In this step, a stainless steel hoop with the surface roughness (Ra)—to-be-managed is made in a tube shape. To this end, forming rollers are arranged in series and the number of forming rollers used for the forming step is properly determined according to the width and thickness of a stainless steel hoop or the hardness or strength of a stainless steel hoop.

Before the hoop is completely formed into a tube shape, a flux mixture containing 500 ppm (or below) moisture is poured into the tube. At this time, if the filling ratio is less than 10%, it fluctuates a lot to the longitudinal direction of the wire, resulting in the deterioration in the quality of welding wires. Meanwhile, if the filling ratio exceeds 30%, the mixture flux may overflow out of the tube and wires can be broken during the drawing process. For these reason, the present invention set the filling ratio to fall within a range of 10 to 30% by weight with respect to the total weight of wires.

Drawing Step

The wire thusly formed undergoes the primary and secondary drawing steps using a lubricant illustrated in Table 3 (to be described). Since the work hardening of a flux cored wire for welding stainless steel is severe during the drawing step, bright annealing (1000-1200° C.) is carried out after the primary drawing step to moderate the degree of work hardening, and the secondary drawing step is carried out to make an accumulated reduction ratio after the bright annealing process ranges between 38% and 60%. Here, the accumulated reduction ratio refers to the sum of deduction ratios in the respective dies as the formed wire passes through plural dies

Examples of drawing methods useful for the manufacture of flux cored wires for welding stainless steel according to the present invention include (i) utilizing PCD dies for both primary and secondary drawing steps; (ii) utilizing CRD for the primary drawing step and PCD dies for the secondary drawing step; and (iii) utilizing CRD for both primary and secondary drawing steps and utilizing PCD dies for the last phase in the drawing step. In this manner, it is possible to maintain the actual tensile strength of a finished wire product within the range of 110-150 kgf/mm², the surface roughness (Ra) 0.15-0.50 μm, and the surface microhardness (Hv) 370-500 Hv.

Irrespective of using PCD or CRD, if properties of a finished wire can be kept within the above-described ranges, one can obtain flux cored wires for welding stainless steel with superior feedability and excellent defect resistance. Especially, it is recommended to use PCD drawing dies to finish up the drawing process if CRD was used during the secondary drawing process. This is because if CRD is used till the end of the drawing process, it becomes very difficult to control the shape of a wire, that is, obtain excellent wire roundness. Further, in the case that the accumulated reduction ratio in the secondary drawing step is below 38%, the finished wire product is not sufficiently hardened, resulting in a low surface hardness, low actual tensile strength and unstable feedability. In contrast, if the accumulated reduction ratio exceeds 60%, the surface roughness (Ra) of the finished wire product is lowered, and thus the wire is often slipped out of a feed roller during feeding. Moreover, as the work hardning of the finished wire product increases, wire drawing speed is reduced and a greater amount of dies is consumed, consequently leading to lower productivity.

A dry lubricant is now explained below.

In case of using PCD dies during the primary and secondary drawing steps, a dry lubricant containing sodium stearate and fatty acids is used for drawing; while in case of using CRD, a dry lubricant containing MoS₂ and graphite is used for drawing. Particularly, in the secondary drawing step, a lubricant box is emptied prior to the last PCD drawing so as to minimize the amount of lubricant residue on the surface of the wire. As a result, the degreasing capability is enhanced in a later step for physically removing the lubricant residue.

On the other hand, in the case that PCD dies are used during the primary and secondary drawing steps and that a lubricant used does not contain sodium stearate and fatty acids but consists of inorganic substances only, drawbility is deteriorated and high-speed wire drawing process results in the snapping of the wire. Moreover, since the stearic acid is composed of C, H, and O groups, an excessive amount of such components sometimes remains on the surface of a finished wire product, which in turn leads to weld defects. To complement these shortcomings, a small amount of MoS₂ and graphite is added to the sodium stearate, whereby defect resistance as well as feedability of the wire can be improved.

Desirably, the lubricant contains by weight 40-85% of at least one compound selected from the group consisting of sodium stearate and fatty acids, 10-50% of at least one compound selected from the group consisting of sodium carbonate and calcium hydroxide, and at least one remainder selected from the group consisting of MoS₂, talc and graphite. To explain why these limits are set, if the content of the compound(s) selected from the group consisting of sodium stearate and fatty acids is below 40% by weight, it is difficult to ensure sufficient lubricativeness which is regarded to be very important during the drawing step using PCD dies, and this leads to deterioration in drawbility and wire feedability. On the other hand, if the content exceeds 85% by weight, the wire may easily slip out of the feed roller and as a result, arc becomes unstable, the amount of the lubricant residue on the wire surface increases, and weld defects are generated. Therefore, in order to achieve improved wire feedability, the content of sodium stearate and/or fatty acids in the lubricant must lie within the range of 40-85% by weight.

Similarly, if the content of a compound selected from the group consisting of sodium carbonate and calcium hydroxide is below 10% by weight, drawbility becomes deteriorated and this leads to low work efficiency. In contrast, if the content exceeds 50% by weight, the amount of the lubricant residue on the wire surface is increased, resultantly generating weld defects. Therefore, in order to achieve good drawbility and superior welding properties, the content of sodium carbonate and/or calcium hydroxide in the lubricant must fall in the range of 10-50% by weight.

Meanwhile, the use of CRD during the primary and secondary drawing steps and the use of an organic substance such as sodium stearate and fatty acids instead of an inorganic substance such as MoS₂ and graphite as a lubricant, the CRD is easily damaged, causing an increase of manufacturing cost and deterioration in the efficiency of manufacturing processes.

In this case, the lubricant desirably contains by weight 20-40% of MoS₂, 50-75% of at least one compound selected from the group consisting of graphite and carbon fluoride, and at least one remainder selected from the group consisting of industrial mineral oils and naphthalene. Among the components, MoS₂ serves to reduce feed resistance of a wire in a conduit cable during welding and thus, to improve wire feedability. Therefore, if the content of MoS₂ is below 20% by weight, the effect of reduction in feed resistance of a wire becomes insignificant, which in turn leads to an unstable wire feeding and low welding efficiency. On the other hand, if the content exceeds 40% by weight, the amount of the lubricant residue on the wire surface is increased and this accumulated lubricant inside the conduit cable during welding adversely affects the feedability. Therefore, the content of MoS₂ in the lubricant must lie within the range of 20 to 40%.

Next, if the content of one compound selected from the group consisting of graphite and carbon fluoride is below 50% by weight, a drawing operation is deteriorated and an arc becomes unstable due to unstable conductivity between the welding tip and the wire. Meanwhile, if the content exceeds 75% by weight, the compound is released from the wire and clogs the conduit cable and the welding tip. In consequence, wire feedability and conductivity are reduced and an arc becomes unstable. Therefore, in order to improve wire feedability and conductivity, the content of graphite and/or carbon fluoride in the lubricant must fall within the range of 50-75%.

Moreover, by emptying at least one block at the end during the secondary drawing process, the amount of the lubricant consumed can be minimized. In this manner, it is possible to improve the degreasing capability in a later step for physically removing the lubricant residue.

Bright Annealing Step

In the bright annealing step, work hardening of a central line drawn first is moderated, and work hardening of a wire is moderated under high-temperature reduction atmosphere conditions so as to burn and remove the lubricant residue on the wire surface during the drawing process. Desirably, the bright annealing step is carried out at a temperature of 1000-1200° C. for 10-30 seconds under reduction atmosphere conditions using N₂, H₂ or NH₄ gas.

Physically Removing Lubricant Residue on Wire Surface

The lubricant residue on the wire surface after the drawing process is usually removed physically. For example, the surface may be ground with wool felt or a disc shaped luffa or grinding stones.

Coating Wire Surface with Surface Treatment Agent

In order to improve feedability and defect resistance of the surface of the finished wire product, the wire is coated with a surface treatment agent. Desirably, the surface treatment agent is an inorganic substance containing by weight 20-40% of MoS₂, 50-75% of at least one compound selected from the group consisting of graphite and carbon fluoride, and at least one remainder selected from the group consisting of industrial mineral oils and naphthalene. To prevent the wire surface from being coated with an excessive amount of the surface treatment agent, it is ground or polished with an abrasive cloth right after the surface treatment coating. In this way, the wire can have a uniform surface.

The following now describes properties of the finished wire.

For the flux cored wire for welding stainless steel thusly manufactured to have superior feedability and excellent fault tolerance, the actual tensile strength of the wire should fall within the range of 110-150 kgf/mm², the surface microhardness (Hv) 370-550 Hv, the surface roughness (Ra) 0.15-0.50 μm, and the total moisture content in the surface of the finished wire should not be higher than 500 ppm.

For instance, if the actual tensile strength of the wire is less than 110 kgf/mm², the welding wire may bend inside a conduit cable during welding, leading to bad feedability. Likewise, if it is greater than 150 kgf/mm², frictional resistance inside the bent conduit cable is increased and the wire feedability can be deteriorated. In addition, toughness of the wire is extremely reduced and thus, the wire may be broken. For this reason, the actual tensile strength of the finished wire should be in the range of 110-150 kgf/mm².

Moreover, if the surface microhardness of the wire is below 370 Hv, the wire can be bent in the feed roller during wire feeding and wire feeding and welding may be interrupted. Meanwhile, if the surface microhardness of the wire exceeds 500 Hv, drawability during the drawing process is deteriorated and the wire can be broken. Thus, the surface microhardness of the finished wire should be in the range of 370-500 Hv.

Next, if the surface roughness (Ra) of the wire is below 0.15 μm, the wire may be slipped from the wire feed roller during welding, or the surface treatment agent such as MoS₂ or graphite cannot be uniformly coated onto the rough surface of the wire. As a result, frictional resistance inside the conduit cable is increased and wire feedability is deteriorated. On the other hand, if the surface roughness (Ra) of the wire exceeds 0.50 μm, the rough surface of the wire is coated with too much lubricant. Therefore, the conduit cable clogged with the lubricant during the long-time welding process increases feed resistance of the wire. Accordingly, the surface roughness (Ra) of the finished wire should be in the range of 0.15 to 0.50 μm.

Lastly, if the total moisture content in the surface of the finished wire inclusive of the amount of moisture adsorbed during the manufacturing process exceeds 500 ppm, weld defects are caused to the surfaces of the welding beads during welding. Therefore, the total moisture content in the surface of the finished wire should not be higher than 500 ppm.

A preferred embodiment of the present invention will now be described with reference to the accompanying drawings. It is also to be understood that the terminology used herein is for the purpose of describing particular embodiments only, and is not intended to be limiting.

[Embodiment]

A stainless steel hoop (100) with the compositions shown in Table 1 was cleaned and degreased (101). One of the flux mixtures shown in Table 2 was selected, filled (108) and formed (102) in a tube shape using forming rollers (102a and 102b). Then, the lubricants (109a and 109b) selected from Table 3 were coated onto the hoop, and the drawing process was carried in two steps. Prior to the drawing process, at least 10 kinds of flux mixtures including rutile sand, silica and iron powder were used. Each flux was mixed and heated at 950° C. or above for at least 1 hour. The amounts of moistures evaporated into the air were calculated by the weight reduction method, and the result was managed as the total moisture content with respect to the weight of the flux mixture. Especially, in order to find out the effect of the total moisture contents of the flux mixtures, the inventors warehoused for raw materials or selected diverse flux materials as resources for the same oxide. The final flux components are shown in Table 2.

The primary drawing step was carried out using PCD dies or CRD and a lubricant selected from Table 3 below (103). Work hardening of a central line drawn first was moderated, and bright annealing was performed (104) at a temperature of 1000-1200° C. for 10-30 seconds under reduction atmosphere conditions using N₂, H₂ or NH₄ gas, so as to remove the lubricant residue during the drawing process.

TABLE 3

| No. | Components of wire drawing lubricant (wt. %) |
|---|---|
| a | Sodium stearate 45%, Fatty acids 35%, Calcium hydroxide 15%, |
| | MoS₂ 5% |
| b | Sodium stearate 30%, Fatty acids 45%, Sodium carbonate 15%, |
| | Graphite 10% |
| c | Fatty acids 50%, Sodium carbonate 10%, Calcium hydroxide 30%, |
| | Talc 10% |
| d | MoS₂ 30%, Graphite 65%, Industrial mineral oils 5% |
| e | MoS₂ 30%, Graphite 30%, Carbon fluoride 30%, |
| | Naphthalene 10% |

In the case that CRD is used during the secondary drawing step (105) after bright annealing, the wire was rolled with CRD up to 1.1 times the diameter of the finished wire product, and adjusted to the diameter of the finished wire product using PCD dies at the end. To control properties of the finished wire product, the accumulated reduction ratio (38-60%) was varied after bright annealing and the actual tensile strength, surface microhardness and surface roughness (Ra) of the finished wire product were measured.

First of all, the actual tensile strength of the finished product was measured as follows:

(i) Cut the finished product wire in the cross direction, grind the wire to a particle size of 1 μm, and polish;

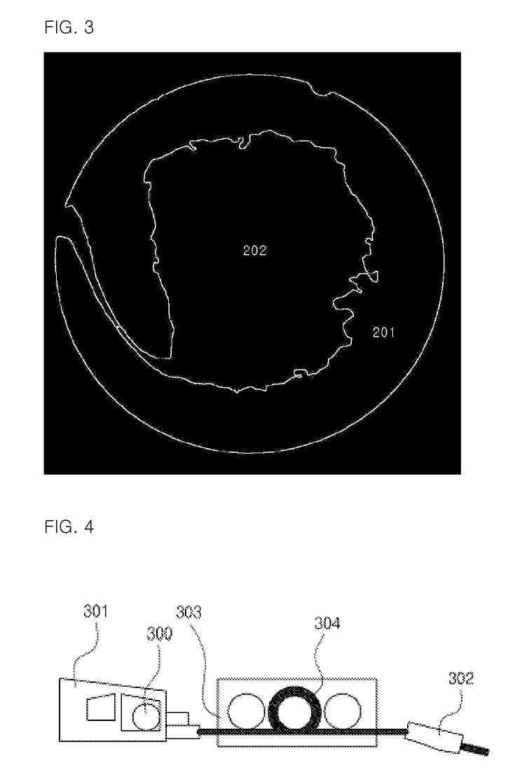

(ii) Using an image analysis system, obtain the area of the wire's cross section and the internal porosities (total pore space) shown in FIG. 3. The image analysis system used here is image-pro plus 4.0 of media cybernetics;

(iii) Use the portion obtained by subtracting the internal porosities out of the wire's cross-section as the area of the actual tensile strength; and

(iv) Cut the finished wire product in about 20 cm and carry out a test of tension 10 times per test piece using Z050 tension tester (manufactured by Zwick, Inc.). Using an average thereof as the result of tension test, obtain the actual tensile strength value based on the aforementioned actual tensile strength area in steps (ii) and (iii).

The following now describes how to measure surface microhardness of the finished product.

(i) Cut the finished wire product in 5 cm for sampling;

(ii) Using VMHTMOT penetrometer (manufactured by LEICA, Inc.), measure hardness at 12 consecutive points along the worked surface in the longitudinal direction of the wire under 1 g of pressured load; and

(iii) Average 10 points except for the maximum and minimum values among the measurement obtained in the step (ii) and take the average as a surface microhardness.

The following now describes how to measure surface roughness of the finished product.

(i) Cut the finished wire product in 10 cm for sampling;

(ii) Using DH-5 surface roughness measuring device (manufactured by DIAVITE, Inc.), measure at least five times surface roughness values of test pieces in four directions except for a seam; and

(iii) Average the measured surface roughness values obtained from the step (ii) and take the average as the surface roughness of a test piece.

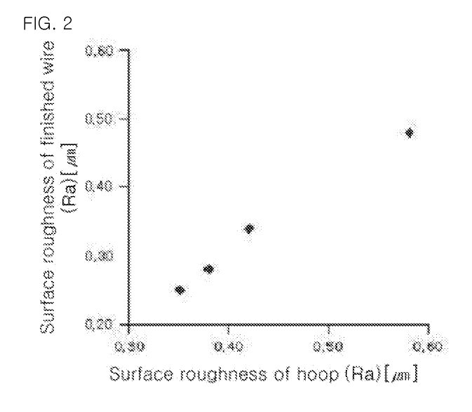

For information, the relation between surface roughnesses (Ra) of the hoop and surface roughnesses (Ra) of the finished wire product is illustrated in FIG. 2. As can be seen in the graph of FIG. 2, provided that PCD dies were used for the primary and secondary drawing steps and that the accumulated reduction ratio during the secondary drawing step is 50%, the surface roughnesses (Ra) of the hoop increased proportionally to the surface roughnesses (Ra) of the finished wire product.

Following the secondary drawing process, the lubricant residue on the wire surface was physically removed, and the surface treatment agent was evenly coated onto the wire to improve feedability and defect resistance of the finished wire product. Then, the total moisture content in the product surface, it being one of main factors of the defect resistance, was measured using RC412 analyzer (manufactured by LECO, Inc.).

Table 6 and Table 7 illustrate examples of the present invention and comparative examples, respectively. Feedability and defect resistance of each wire were tested. The feedabilities were tested using test equipment with an arbitrary bent as shown in FIG. 4 under an atmosphere of 100% carbon dioxide. The test was carried out on a 1.2 mm flux cored wire (finished product) under the welding conditions shown in Table 4. The test results were indicated by “O” where the wire was continuously fed without stops of arc creation during a 3-minute welding period, “Δ” where the arc creation was interrupted once or twice, and “X” where the arc creation was completely stopped due to unstable wire feeding.

TABLE 4

| | | | | Shielding |
|---|---|---|---|---|
| | Welding | Welding voltage | Feed speed | gas |
| Diameter | amperage (A) | (V) | (CPM) | (L/min) |
| 1.2 mm | 180 | 30 | 35 | 20 |

The test of defect resistance was also carried out using the same welding conditions shown in Table 4 under an atmosphere of 100% carbon dioxide. To prepare a test piece for the evaluation of mechanical properties of flux cored wires AWS A5.22, the multilayer welding technique was used and the occurrence of an internal defect was detected with X-ray (1). In addition, a 1.2 mm flux cored wire (finished product) was welded under the welding conditions shown in Table 5 using 100% carbon dioxide and the occurrence of a wormhole in the surface of the weld was detected (2). The test results were indicated by “O” where neither internal defects (1) nor wormholes (2) was found, “Δ” where one or two pores were found in the weld but no wormhole was found, and “X” where both internal defects (1) and wormholes (2) were found or wormholes (2) were found.

TABLE 5

| | | | | Shielding |
|---|---|---|---|---|
| | Welding | Welding voltage | Feed speed | gas |
| Diameter | amperage (A) | (V) | (CPM) | (L/min) |
| 1.2 mm | 280 | 36 | 35 | 10 |

TABLE 6

| | | | | Flux | | | | Bright | | | | |
|---|---|---|---|---|---|---|---|---|---|---|---|---|
| | | | | mixture | | | | annealing | Secondary drawing | | | |
| | | Hoop | | | Total | Primary | | Is | Before the | | | |
| | | | Surface | | moisture | drawing | | annealing | last phase | | Last phase | |
| | | | roughness | | content | Dies | | performed? | Dies | | Dies | |
| DIVISION | | Type | (μm) | Design | (ppm) | used | Lubricant | (Y/N) | used | Lubricant | used | Lubricant |
| INVENTION | 1 | a | 0.42 | a | 160 | PCD | a | Y | PCD | a | PCD | a |
| EXAMPLES | 2 | a | 0.35 | a | 160 | PCD | a | Y | PCD | a | PCD | a |
| | 3 | a | 0.56 | a | 350 | PCD | a | Y | PCD | a | PCD | a |
| | 4 | a | 0.30 | a | 350 | PCD | a | Y | PCD | a | PCD | a |
| | 5 | a | 0.34 | a | 350 | PCD | a | Y | PCD | a | PCD | a |
| | 6 | a | 0.35 | a | 350 | PCD | a | Y | PCD | a | PCD | a |
| | 7 | a | 0.40 | a | 350 | CRD | d | Y | PCD | c | PCD | c |
| | 8 | a | 0.32 | a | 480 | CRD | d | Y | PCD | c | PCD | c |
| | 9 | a | 0.56 | a | 160 | CRD | e | Y | CRD | d | PCD | a |
| | 10 | a | 0.32 | a | 160 | CRD | e | Y | CRD | e | PCD | a |
| | 11 | b | 0.40 | b | 350 | PCD | b | Y | PCD | b | PCD | b |
| | 12 | b | 0.35 | b | 350 | PCD | b | Y | PCD | b | PCD | b |
| | 13 | b | 0.39 | b | 350 | CRD | d | Y | PCD | c | PCD | c |
| | 14 | b | 0.42 | b | 480 | CRD | d | Y | PCD | c | PCD | c |
| | 15 | b | 0.34 | b | 160 | CRD | e | Y | CRD | d | PCD | a |
| | 16 | b | 0.40 | b | 350 | CRD | e | Y | CRD | e | PCD | a |
| | 17 | b | 0.39 | b | 480 | PCD | b | Y | PCD | b | PCD | b |
| | 18 | b | 0.30 | b | 350 | PCD | a | Y | PCD | a | PCD | a |
| | 19 | b | 0.38 | b | 160 | PCD | b | Y | PCD | b | PCD | b |
| | 20 | b | 0.58 | b | 160 | PCD | d | Y | PCD | a | PCD | a |

| | | | Properties of drawn wire | | | | | |
|---|---|---|---|---|---|---|---|---|
| | | | | | | Total | | |
| | | Secondary | | | | moisture | | |
| | | drawing | | Actual | | content | | |
| | | Accumulated | Surface | tensile | | in | Weld | |
| | | reduction | micro | strength | Surface | wire | properties | |
| | | ratio | hardness | (kgf/ | roughness | surface | | Fault |
| DIVISION | | (%) | (Hv) | mm²) | (μm) | (ppm) | Feedability | tolerance |
| INVENTION | 1 | 50 | 444 | 122 | 0.34 | 465 | ◯ | ◯ |
| EXAMPLES | 2 | 50 | 448 | 125 | 0.25 | 380 | ◯ | ◯ |
| | 3 | 46 | 432 | 116 | 0.38 | 448 | ◯ | ◯ |
| | 4 | 57 | 478 | 148 | 0.22 | 364 | ◯ | ◯ |
| | 5 | 38 | 419 | 111 | 0.34 | 430 | ◯ | ◯ |
| | 6 | 60 | 481 | 146 | 0.23 | 378 | ◯ | ◯ |
| | 7 | 50 | 442 | 118 | 0.24 | 381 | ◯ | ◯ |
| | 8 | 55 | 456 | 138 | 0.18 | 356 | ◯ | ◯ |
| | 9 | 46 | 428 | 118 | 0.34 | 398 | ◯ | ◯ |
| | 10 | 38 | 411 | 111 | 0.15 | 252 | Δ | ◯ |
| | 11 | 60 | 467 | 143 | 0.23 | 373 | ◯ | ◯ |
| | 12 | 38 | 402 | 119 | 0.33 | 414 | ◯ | ◯ |
| | 13 | 38 | 375 | 110 | 0.24 | 407 | ◯ | ◯ |
| | 14 | 50 | 430 | 120 | 0.22 | 363 | ◯ | ◯ |
| | 15 | 46 | 412 | 117 | 0.18 | 278 | ◯ | ◯ |
| | 16 | 50 | 414 | 125 | 0.22 | 256 | Δ | ◯ |
| | 17 | 60 | 488 | 143 | 0.21 | 354 | ◯ | ◯ |
| | 18 | 59 | 486 | 147 | 0.20 | 298 | ◯ | ◯ |
| | 19 | 50 | 442 | 124 | 0.28 | 404 | ◯ | ◯ |
| | 20 | 50 | 429 | 127 | 0.48 | 489 | ◯ | Δ |

TABLE 7

| | | | | Flux | | | | Bright | | | | |
|---|---|---|---|---|---|---|---|---|---|---|---|---|
| | | | | mixture | | | | annealing | Secondary drawing | | | |
| | | Hoop | | | Total | Primary | | Is | Before the | | | |
| | | | Surface | | moisture | drawing | | annealing | last phase | | Last phase | |
| | | | roughness | | content | Dies | | performed? | Dies | | Dies | |
| DIVISION | | Type | (μm) | Design | (ppm) | used | Lubricant | (Y/N) | used | Lubricant | used | Lubricant |
| COMPARATVE | 21 | a | 0.45 | a | 350 | PCD | a | Y | PCD | a | PCD | a |
| EXAMPLES | 22 | b | 0.50 | b | 350 | CRD | b | Y | CRD | b | PCD | b |
| | 23 | a | 0.48 | a | 480 | PCD | a | Y | PCD | a | PCD | a |
| | 24 | b | 0.40 | b | 160 | PCD | a | N | PCD | a | PCD | a |
| | 25 | a | 0.40 | a | 520 | PCD | a | N | PCD | a | PCD | a |
| | 26 | a | 0.40 | a | 520 | PCD | a | Y | PCD | a | PCD | a |
| | 27 | a | 0.68 | a | 350 | PCD | d | N | PCD | d | PCD | d |
| | 28 | a | 0.58 | a | 350 | PCD | e | Y | PCD | e | PCD | e |
| | 29 | a | 0.20 | a | 350 | PCD | b | Y | PCD | b | PCD | b |
| | 30 | a | 0.22 | a | 160 | PCD | a | Y | PCD | a | PCD | a |
| | 31 | a | 0.66 | a | 350 | CRD | a | Y | PCD | a | PCD | a |
| | 32 | a | 0.35 | a | 520 | CRD | a | Y | CRD | a | PCD | a |
| | 33 | a | 0.68 | a | 350 | CRD | d | N | CRD | d | PCD | a |
| | 34 | a | 0.39 | a | 350 | CRD | e | Y | CRD | e | CRD | d |
| | 35 | b | 0.40 | b | 520 | PCD | e | Y | PCD | e | PCD | e |
| | 36 | b | 0.68 | b | 480 | PCD | d | Y | PCD | d | PCD | d |

| | | | Properties of drawn wire | | | | | |
|---|---|---|---|---|---|---|---|---|
| | | | | | | Total | | |
| | | Secondary | | | | moisture | | |
| | | drawing | | Actual | | content | | |
| | | Accumulated | Surface | tensile | | in | Weld | |
| | | reduction | micro | strength | Surface | wire | properties | |
| | | ratio | hardness | (kgf/ | roughness | surface | | Fault |
| DIVISION | | (%) | (Hv) | mm²) | (μm) | (ppm) | Feedability | tolerance |
| COMPARATVE | 21 | 34 | 359 | 108 | 0.32 | 420 | X | ο |
| EXAMPLES | 22 | 34 | 351 | 103 | 0.34 | 444 | X | ο |
| | 23 | 65 | 503 | 157 | 0.26 | 520 | Δ | X |
| | 24 | 65 | 534 | 168 | 0.37 | 471 | X | Δ |
| | 25 | 50 | 512 | 152 | 0.44 | 551 | Δ | X |
| | 26 | 50 | 450 | 123 | 0.39 | 514 | ο | X |
| | 27 | 50 | 432 | 129 | 0.54 | 470 | Δ | Δ |
| | 28 | 34 | 364 | 104 | 0.57 | 461 | X | Δ |
| | 29 | 50 | 440 | 128 | 0.13 | 389 | X | ο |
| | 30 | 60 | 465 | 137 | 0.14 | 326 | X | ο |
| | 31 | 34 | 365 | 109 | 0.69 | 410 | X | Δ |
| | 32 | 34 | 359 | 111 | 0.45 | 562 | X | X |
| | 33 | 50 | 462 | 135 | 0.65 | 510 | X | X |
| | 34 | 50 | 408 | 112 | 0.66 | 490 | X | Δ |
| | 35 | 65 | 474 | 152 | 0.22 | 563 | Δ | X |
| | 36 | 50 | 398 | 121 | 0.51 | 408 | Δ | Δ |

As an be seen in Table 6 and Table 7, surface roughnesses (Ra) of stainless hoops in examples 1-20 of the present invention and total moisture contents in flux mixtures were thoroughly checked, and the primary and secondary drawing processes were performed using a proper amount of lubricants listed in Table 3 according to the given drawing method. A bright annealing process was then carried out to moderate work hardening. In result, wire breakage did not occur during the manufacturing processes, and the accumulated reduction ratio during the secondary drawing step fell within the range of 38 to 60%. Irrespective of whether PCD dies or CRD were used, the finished products exhibited superior wire feedability and excellent defect resistance.

On the other hand, in case of the comparative examples 21 and 22, the accumulated reduction ratio during the secondary drawing step was extremely low, regardless of the type of the stainless steel hoops used. This problem has led to extremely low surface microhardness and tensile strength values of the finished wires. Thus, while the finished wires were being fed, they were bent on the position of feed roller and wire feeding stopped momentarily.

In contrast, the comparative examples 23 and 24 exhibited too high accumulated reduction ratio during the secondary drawing step. In these cases, work hardening of the finished products is deteriorated and thus, toughness is reduced and wire breakage occurs during the manufacturing processes. Moreover, frictional resistance in a bent conduit cable increases during wire feeding, resulting in an unstable arc. Especially, in case of the comparative example 23 had too much moisture in its surface and thus, defect resistance thereof was poor.

In case of the comparative examples 25 and 26, the total moisture contents in the flux moistures to be filled in a tube were so high that partially formed wormholes were observed when welding was carried out under the welding conditions of FIG. 5. This proves that the amount of moisture adsorbed by the flux mixture in the tube is a major factor of the occurrence of weld defects. Particularly, according to the result of X-ray reading, the comparative example 25 which did not undergo the bright annealing process formed a number of pores therein during multilayer welding. In addition, surface microhardness and actual tensile strength of the finished wire were increased, resulting in the increase in frictional resistance inside a conduit cable during welding and the deterioration in wire feedability.

The comparative examples 27 and 28 went through the primary and secondary drawing processes using PCD dies and lubricants ‘d’ and ‘e’. Unfortunately however, drawability of each example was poor and the wires were often broken. Also, the surface roughnesses (Ra) thereof were so high that arc creation during the evaluation of feedability in each example was often stopped or interrupted. Moreover, in case of the comparative example 27, since the surface roughness (Ra) of the stainless steel hoop material was high in the beginning, the surface roughness of the finished product was also high and a number of pores were formed in the weld during multilayer welding.

Meanwhile, the surface roughnesses (Ra) of stainless steel hoop materials of the comparative examples 29 and 30 were so low that the surface treatment agent could not be coated evenly onto the rough surfaces of those wires. Consequently, frictional resistance in the conduit cable was increased and feedability was deteriorated in each example. Moreover, formability of each wire was not good, that is, it was difficult to form a tube with the wires. Because of this, flux mixtures could not be filled in the tube uniformly and drawability during the drawing step was not good either. Further, the surface roughnesses (Ra) of the finished products were so low that the wire wound around the feed roller slipped during welding, resultantly deteriorating wire feedability.

In case of the comparative example 31, the inventors tried to roll the wire during the primary drawing step using CRD. However, the surface roughness (Ra) of the stainless steel hoop material was still very high and the accumulated reduction ratio during the secondary drawing step was low. As a result, the wire was so easily bent that wire feeding itself had to be stopped. In addition, due to the great amount of the lubricant residue on the rough surface of the finished wire adversely affected defect resistance and several wormholes were observed on the surface of the weld.

The comparative example 32 was manufactured by carrying out CRD rolling on the primary and secondary drawing processes using an organic lubricant. When the welding process was performed using the welding conditions illustrated in Table 5 under an atmosphere of 100% carbon dioxide, the total moisture content of the flux mixture filled in the tube was so high that minute weld defects occurred to the surfaced of welding beads. Moreover, as the accumulated reduction ratio during the secondary drawing step was low, the surface microhardness of the wire was not sufficiently and therefore, the feed roller was bent during welding, resulting in unstable feedability. In addition, the use of an organic lubricant ‘a’ for CRD rolling reduced lifespan of CRD and increased the manufacturing cost.

On the other hand, the comparative example 33 was manufactured by carrying out CRD rolling on the primary and secondary drawing processes using an inorganic lubricant. At the same time, the inventors carefully managed the total moisture content of the flux mixture in the tube and the comparative example 33 was designed to have a proper accumulated reduction ratio during the secondary drawing step so that the finished wire product can be sufficiently hardened. Nevertheless, the surface roughness (Ra) of the hoop used initially was high, and in the absence of the bright annealing process too much lubricant remained on the surface of the finished product, resultantly leading to weld defects.

Likewise, the comparative example 34 was manufactured by carrying out CRD rolling on the primary and secondary drawing processes using an inorganic lubricant, and the inventors carefully managed the total moisture content of the flux mixture in the tube and the accumulated reduction ratio during the secondary drawing step. Unfortunately however, because PCD dies were not used in the last phase of the secondary drawing step, roundness (precision) of the sectional shape of the finished wire product was decreased and this in turn adversely affected wire feedability.

The comparative example 35 was manufactured by means of PCD dies during the primary and secondary drawing processes using an inorganic lubricant. However, lubricativeness of the lubricant used was not satisfactory and the accumulated reduction ratio during the secondary drawing step was so high that wire breakage often occurred during the drawing process. Besides, the wire often slipped from the feed roller during the welding process, and high moisture content in the flux mixture adversely affected defect resistance.

A similar phenomenon as in the comparative example 35 was observed in the comparative example 36. However, the lubricant ‘d’ was not sufficiently lubricative to be used with PCD dies, so wire breakage occurred during the drawing process and this in turn deteriorated wire feedability while welding the finished product. In addition, since the surface roughness (Ra) of the hoop was high, too much lubricant remained on the surface of the finished product, leading to poor defect resistance. That is, the surface roughness (Ra) of the finished product increases proportionally to the surface roughness (Ra) of the hoop, and a greater amount of the lubricant remains on a rougher surface. Consequently, weld defects occurred more frequently during the welding process.

As explained so far, the methods of the present invention can be advantageously used for the manufacture of flux cored wires for welding stainless steel having seams formed therein, which features superior feedability and excellent defect resistance.

Especially, by manufacturing wire products with PCD drawing dies, the combination of PCD dies and CRD, or CRD rolling and by properly controlling the physical properties of the finished wire product and the total moisture content therein, it is possible to manufacture flux cored wires for welding stainless steel offering superior feedability and excellent defect resistance without carrying out the baking process.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A method for manufacturing a flux cored wire for welding stainless steel of 0.9-1.6 mm in diameter having a seamed portion, the method comprising the steps of:
forming a hoop (stainless steel 304L or 316L) into a U-shape and filling the hoop with a flux mixture, thereby forming a tube having a seamed portion;
performing a primary drawing process on the tube shaped wire using a lubricant;
performing a bright annealing process to relieve work hardening of the primarily drawn wire;
performing a secondary drawing process on the wire until an accumulated reduction ratio after the bright annealing process falls within the range of 38-60%;
physically removing a lubricant residue on the surface of the secondarily drawn wire; and
coating the wire with a surface treatment agent.

2. The method of claim 1, wherein surface roughness (Ra) of the hoop lies within the range of 0.30 to 0.60 μm.

3. The method of claim 1, wherein the flux mixture filled in the U-shaped hoop contains moisture not higher than 500 ppm in total.

4. The method of claim 1, wherein PCD dies or CRD are used from the tube shaped wire to a wire having an almost same diameter with a finished product and the drawing process is finished with PCD dies.

5. The method of claim 4, wherein a lubricant used during the PCD drawing step contains by weight 40-85% of at least one compound selected from the group consisting of sodium stearate and fatty acids, 10-50% of at least one compound selected from the group consisting of sodium carbonate and calcium hydroxide, and at least one remainder selected from the group consisting of MoS₂, talc and graphite; and
wherein a lubricant used during the CRD drawing step contains by weight 20-40% of MoS₂, 50-75% of at least one compound selected from the group consisting of graphite and carbon fluoride, and at least one remainder selected from the group consisting of industrial mineral oils and naphthalene.

6. The method of claim 1, wherein an actual tensile strength of the finished wire following the drawing step is in the range of 110 to 150 kgf/mm², a surface roughness (Ra) 0.15 to 0.50 μm, and a surface microhardness 370 to 500 Hv, wherein the surface microhardness is obtained by measuring microhardnesses on 12 points on a worked surface in the longitudinal direction of the wire and then averaging the microhardnesses on 10 points exclusive of a maximum value and a minimum value.

7. The method of claim 1, wherein the surface treatment agent which is lastly coated onto the wire surface contains by weight 20-40% of MoS₂, 50-75% of at least one compound selected from the group consisting of graphite and carbon fluoride, and at least one remainder selected from the group consisting of industrial mineral oils and naphthalene.

8. A flux cored wire for welding stainless steel manufactured by one of methods described in claims 1 through 7, wherein a finished wire surface contains moisture not higher than 500 ppm with respect to the total weight of the wire.
